(19) United States
(12) Patent Application Publication
(10) Pub. No.: US 2026/0085929 A1
(43) Pub. Date: Mar. 26, 2026

(54) MEASUREMENT APPARATUS, MEASUREMENT METHOD, STORAGE MEDIUM, AND MANUFACTURING METHOD

(71) Applicant: CANON KABUSHIKI KAISHA, Tokyo (JP)

(72) Inventor: KEITA DAN, Tokyo (JP)

(21) Appl. No.: 19/338,755

(22) Filed: Sep. 24, 2025

(30) Foreign Application Priority Data
Sep. 26, 2024 (JP) 2024-167062

(51) Int. Cl. G01B 11/25; G06T 7/521; G06T 7/55

(52) U.S. Cl. CPC G01B 11/254; G06T 7/521; G06T 7/55

(57) ABSTRACT

An apparatus that performs three-dimensional measurement, the apparatus includes a projection unit configured to project pattern light onto an object to be measured, a camera including a first camera and a second camera, the camera being configured to capture images of the object, and a processing unit configured to process data acquired from the camera, wherein the processing unit derives a first evaluation result from a first image with a pattern acquired by the first camera and a second image with a pattern acquired by the second camera in a state in which the pattern light is projected, and wherein the processing unit derives a countermeasure for improving accuracy of the three-dimensional measurement based on the first evaluation result.

### BACKGROUND

### Field of the Technology

The aspect of the embodiments relates to a measurement apparatus, a measurement method, a storage medium, and a manufacturing method.

### Description of the Related Art

In recent years, on production lines for industrial products and the like, assembly operations have been performed by assembly production equipment including robotic devices instead of manual labor.

In such production systems, cameras and image processing apparatuses may be used to measure and inspect workpieces required for assembly operations. For example, in a case where depth information is required for measurement and inspection, a stereo camera including two or more cameras may be used to perform three-dimensional measurement of a target object based on the principle of triangulation. In this type of three-dimensional measurement, differences (parallax) between the positions of the object in a plurality of images captured by the plurality of cameras are calculated for each camera, and the resultant parallax values are each converted into a depth amount, whereby the three-dimensional information is obtained. In general, determining the parallax is referred to as stereo matching processing.

In the stereo matching processing, when a texture in the images of a workpiece is weak, the accuracy of the calculated parallax may decrease. The texture here refers to patterns or marks that appear in images due to variations in brightness. There is a known method of performing the stereo matching processing by projecting light with textures (i.e., pattern light) onto workpieces using a pattern light projection unit. In this case, if overexposure or underexposure occurs in images of the workpieces, the accuracy of the parallax calculated in the stereo matching processing may decrease.

For example, Japanese Patent Laid-Open No. 2016-75658 describes an information processing system and an information processing method capable of preventing decrease in subject recognition accuracy.

### SUMMARY

According to an aspect of the embodiments, an apparatus that performs three-dimensional measurement, the apparatus includes a projection unit configured to project pattern light onto an object to be measured, a camera including a first camera and a second camera, the camera being configured to capture images of the object, and a processing unit configured to process data acquired from the camera, wherein the processing unit derives a first evaluation result from a first image with a pattern acquired by the first camera and a second image with a pattern acquired by the second camera in a state in which the pattern light is projected, and wherein the processing unit derives a countermeasure for improving accuracy of the three-dimensional measurement based on the first evaluation result.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a three-dimensional measurement apparatus according to a first embodiment.

FIG. 2 is a diagram illustrating an apparatus configuration of a stereo camera according to the first embodiment.

FIG. 3 is a functional block diagram of an image processing apparatus according to the first embodiment.

FIG. 4 is a diagram illustrating parameters of the three-dimensional measurement apparatus according to the first embodiment.

FIG. 5 is a diagram illustrating a stereo matching method according to the first embodiment.

FIG. 6 is a schematic view of an apparatus configuration according to the first embodiment.

FIG. 7 is a flowchart illustrating a method for estimating a factor of accuracy degradation according to the first embodiment.

FIG. 8 is a flowchart illustrating the method for estimating the factor of accuracy degradation according to the first embodiment.

FIG. 9 is a diagram illustrating an example of a display screen of a three-dimensional measurement application according to the first embodiment.

FIG. 10 is a diagram illustrating an example of the display screen of the three-dimensional measurement application according to the first embodiment.

FIGS. 11A to 11C are diagrams illustrating examples of captured images in which overexposure occurs according to the first embodiment.

FIG. 12 is a diagram illustrating an epipolar disparity according to the first embodiment.

FIG. 13 is a diagram illustrating an example of captured images according to a second embodiment.

FIG. 14 is a diagram illustrating an example of a display screen of a three-dimensional measurement application according to the second embodiment.

FIG. 15 is a flowchart illustrating a method for estimating a factor of accuracy degradation according to a third embodiment.

FIG. 16 is a diagram illustrating an example of a display screen of a three-dimensional measurement application according to the third embodiment.

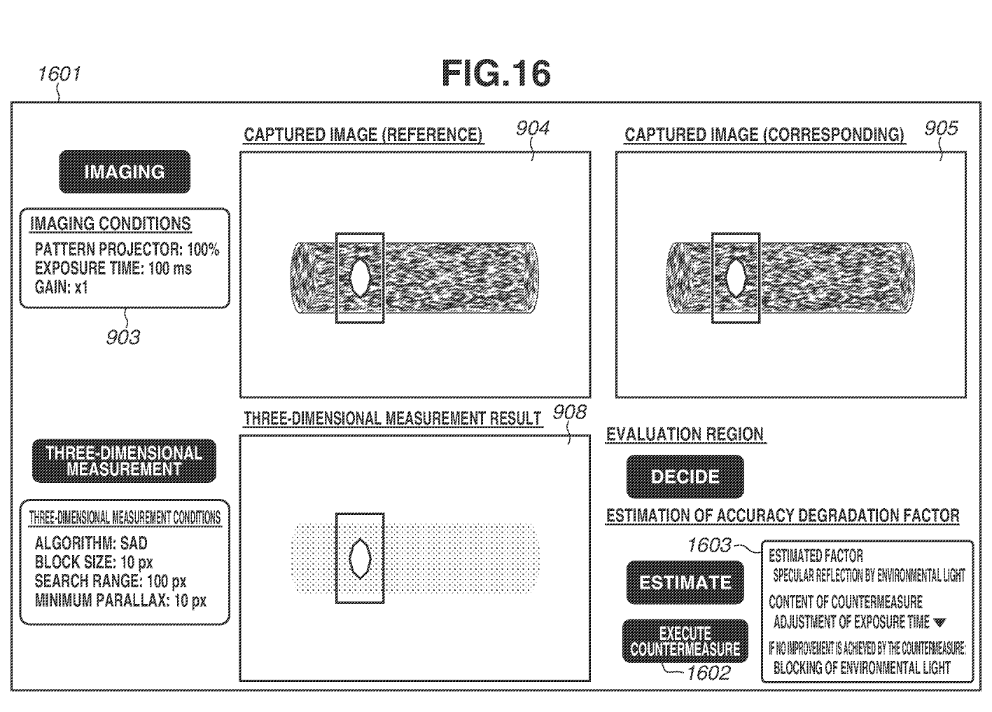

### DESCRIPTION OF THE EMBODIMENTS

Some embodiments for carrying out the present disclosure will now be described with reference to the accompanying drawings. The embodiments described below are merely examples. For example, those skilled in the art can change detailed configurations as appropriate without departing from the spirit of the present disclosure. In addition, the numerical values discussed in the present embodiments are numerical values that serve as references for describing the present embodiments, and do not limit the present disclosure.

### First Embodiment

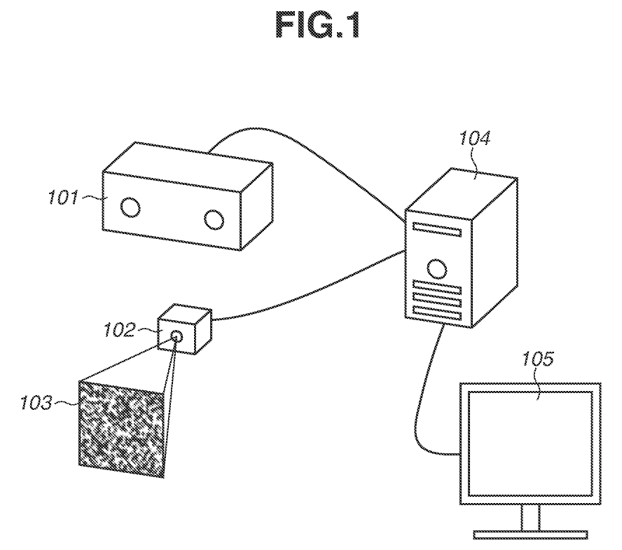

FIG. 1 illustrates a configuration of a three-dimensional measurement system using a stereo camera and a pattern light projection unit in the present embodiment. The three-dimensional measurement system is used, for example, in an inspection process on a production line for inspecting items manufactured in a manufacturing process.

The three-dimensional measurement system in the present embodiment is configured such that a stereo camera 101 and a pattern light projection unit 102 are connected to an image processing apparatus 104 having a function of an image processing unit, for example. In the following description of the present embodiment, the image processing apparatus 104 and the stereo camera 101 are described as separate apparatuses, but the image processing apparatus 104 may be built in the stereo camera 101, like a smart camera. Such a configuration eliminates the need for wiring between the stereo camera 101 and the image processing apparatus 104, significantly reducing the number of steps required to install the system.

A connection cable between the stereo camera 101 and the image processing apparatus 104 constitutes a communication interface between the stereo camera 101 and the image processing apparatus 104, and includes a power line, a communication line for transmitting and receiving image data, and an input and output (IO) line used in communication control or the like. The communication interface can be configured based on a standard, such as Universal Serial Bus (USB).

A connection cable between the pattern light projection unit 102 and the image processing apparatus 104 constitutes a communication interface between the pattern light projection unit 102 and the image processing apparatus 104, and includes a power line, a communication line for transmitting and receiving illumination adjustment control values, and an IO line used for communication control or the like. The pattern light projection unit 102 incorporates a light emitting diode (LED) and a glass chart on which a pattern is drawn, and has a function of turning on and off pattern light 103 in response to instructions from the image processing apparatus 104. The pattern light projection unit 102 can also illumination adjustment control of the pattern light 103 in response to an instruction from the image processing apparatus 104. For example, the illumination adjustment control can be performed by transmitting a pulse width modulation (PWM) signal from the image processing apparatus 104 to the pattern light projection unit 102.

The image processing apparatus 104 and a display 105 that functions as a display unit are connected using a video cable, and video images can thus be output from the image processing apparatus 104 and displayed on the display 105. This communication interface can be configured based on a standard, such as High-Definition Multimedia Interface (HDMI®).

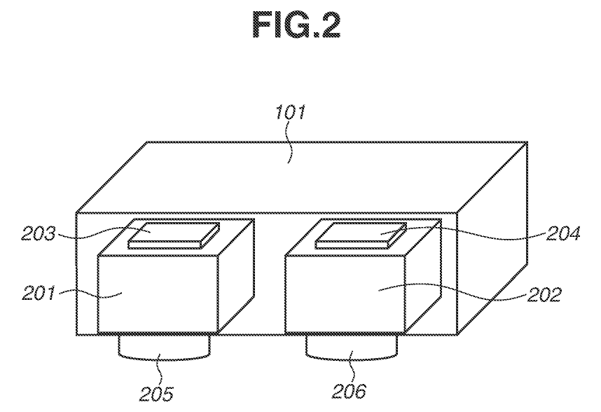

As illustrated in FIG. 2, the stereo camera 101 includes a monocular camera (a first camera) 201 and a monocular camera (a second camera) 202, both of which are arranged with their respective imaging optical axes separated by an appropriate baseline length. The monocular camera 201 and the monocular camera202 include an image sensor 203 and an image sensor 204, a lens 205 and a lens 206, respectively, allowing desired image capturing. Each of the image sensors 203 and 204 is a charge coupled device (CCD) or a complementary metal oxide semiconductor (CMOS) image sensor, for example.

Image data captured by the stereo camera 101 can be transmitted to the image processing apparatus 104 via the above-described communication interface. Further, imaging parameters, which are setting information at the time of imaging, can be controlled based on setting commands or the like received from the image processing apparatus 104 of the stereo camera 101 or the like via the above-described communication interface. The imaging parameters include, for example, exposure time, gain, and image size.

The image processing apparatus 104 can include hardware, such as a calculation unit including a central processing unit (CPU) and a graphics processing unit (GPU), a memory unit including a read-only memory (ROM) and a random-access memory (RAM), and an interface (I/F) unit for communicating with an external device. The image processing apparatus 104 in the present embodiment also includes an imaging control function for the stereo camera 101 as described below, and conceptually may be considered to be a control device that performs imaging control through image processing.

The image processing apparatus 104 can also be provided with a user interface (UI) device. The user interface device may be a graphical user interface (GUI) device including, for example, a display 105, a keyboard, and a pointing device (a mouse, a joystick, a jog dial, or the like). The user interface device can be used to notify a user of captured images and three-dimensional measurement results, and the like, and to set regions for evaluating a factor of accuracy degradation described below.

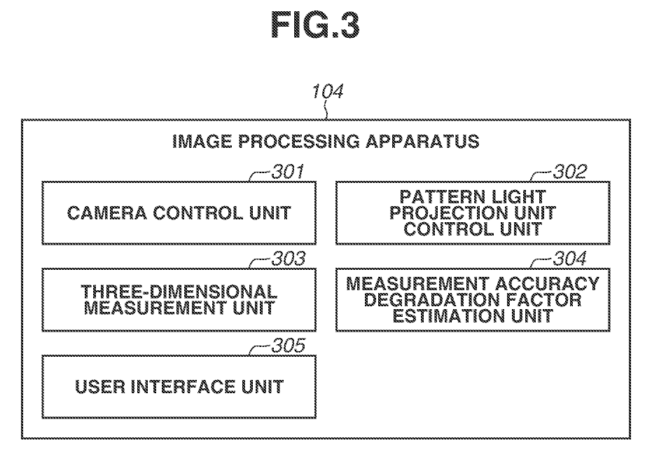

FIG. 3 is a functional block diagram of the image processing apparatus 104. The image processing apparatus 104 has functions of a camera control unit 301, a pattern light projection unit control unit 302, a three-dimensional measurement unit 303, a measurement accuracy degradation factor estimation unit 304, and a user interface unit 305. For example, each of these functional blocks may be implemented by the above-described calculation unit reading and executing programs stored in the memory unit.

An overview of the functional blocks 301 to 305 of the image processing apparatus 104 will now be described. The camera control unit 301 controls the imaging operation of the monocular cameras 201 and 202 in the stereo camera 101. The imaging operation is, for example, performed in the following manner.

First, power is supplied to the monocular cameras 201 and 202, and initialization instructions are transmitted from the camera control unit 301. Upon completion of the initialization of the monocular cameras 201 and 202, instructions to change the imaging parameters are transmitted to the monocular cameras 201 and 202.

Upon completion of the adjustment of the imaging parameters, the camera control unit 301 transmits an imaging trigger signal to each of the monocular cameras 201 and 202 to cause the monocular cameras 201 and 202 to output captured image data. The camera control unit 301 stores the received image data in a memory unit, such as a random-access memory (RAM) accessible by other functional blocks.

As described above, the pattern light projection unit control unit 302 has functions of performing on and off control and illumination adjustment control of the pattern light projection unit 102. This pattern projection control is performed by transmitting PWM signals to the pattern light projection unit 102 via an IO line, for example.

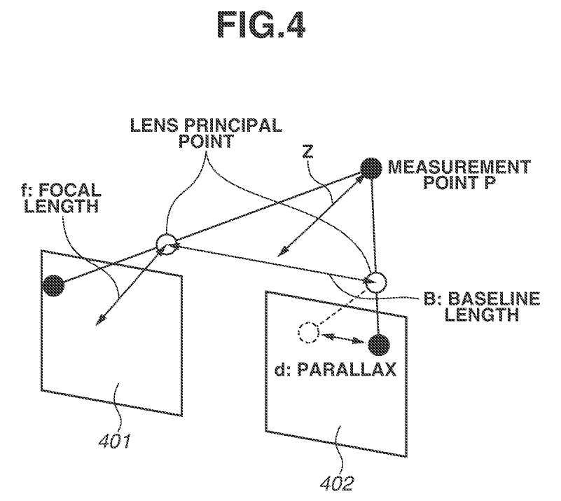

The three-dimensional measurement unit 303 performs three-dimensional measurement using images captured by the monocular cameras 201 and 202 of the stereo camera 101. The three-dimensional measurement unit 303 can calculate a distance based on the principle of triangulation as illustrated in FIG. 4 using a parallax d obtained from the stereo matching processing described below and intrinsic and extrinsic parameters obtained by stereo camera calibration. The intrinsic parameters refer to optical characteristics, such as a focal length f and distortion characteristics of the lens. The extrinsic parameters refer to a relative position and an orientation including a baseline length B, which is the distance between the lens principal points of the two monocular cameras 201 and 202 in the stereo camera 101.

The intrinsic parameters and the external parameters are generally calculated using an optimization-based calibration method in which a calibration chart with a known geometry is captured in advance, and the positions of a plurality of feature points in the calibration chart are measured so that the epipolar constraint condition is satisfied for those feature points. The epipolar constraint here is a constraint condition that corresponding points in the images captured by the two cameras of the stereo camera exist on the same plane (an epipolar plane). The epipolar plane passes through the lens principal points of the two cameras and the measurement points. The intrinsic parameters and the external parameters calculated in advance for the monocular cameras 201 and 202 are stored in, for example, the ROM in the image processing apparatus 104.

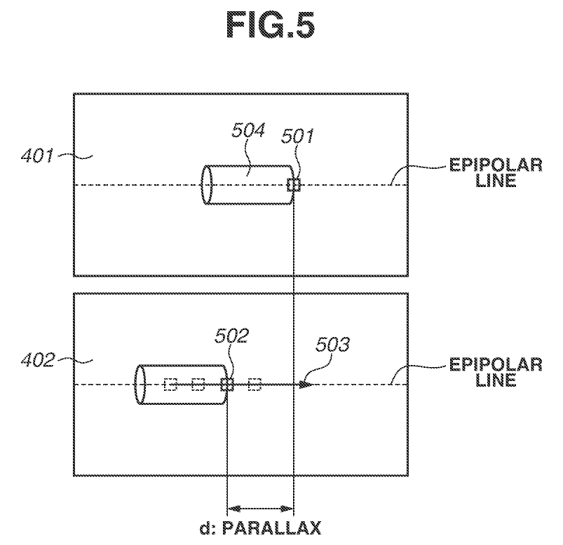

The stereo matching processing of determining the parallax d will now be described. For example, as illustrated in FIG. 5, an image of a workpiece 504, which is an object to be measured, captured by the monocular camera 201 is set as a reference image 401, and an image of the workpiece 504 captured by the monocular camera 202 is set as a corresponding image 402. A reference block 501 is set in the reference image 401, and a corresponding block, i.e., a region with the same specific part of the subject captured, is identified by searching the corresponding image 402.

In this case, it is known that a corresponding block 502 in the corresponding image 402 exists on the epipolar line, and thus, the search is performed on the epipolar line. The epipolar line is the intersection line between the above-described epipolar plane and the corresponding image 402. A search range 503 can be set as a parameter for three-dimensional measurement, and is stored, for example, in the ROM in the image processing apparatus 104. The distance between the reference block 501 and the corresponding block 502 in the image is the parallax d.

As a method for performing such processing, there are known block matching methods, such as sum of absolute difference (SAD), sum of squared difference (SSD), and semi-global matching (SGM). Such known matching processing methods can also be used in the present embodiment.

The following is a description of three-dimensional measurement by rectifying stereo images using the intrinsic and extrinsic parameters. Stereo rectification refers to correcting camera lens distortion and transforming stereo images into the equivalent of images captured by two cameras positioned in parallel. When the rectification processing is performed, a measurement result z in a Z direction (a depth direction of the image) can be expressed as z = Bf/d based on the principle of triangulation. As described above, the three-dimensional measurement unit 303 has a function of performing three-dimensional measurement using captured images.

The measurement accuracy degradation factor estimation unit 304 has a function of estimating a factor of degraded accuracy of the three-dimensional measurement caused by image anomalies, such as overexposure in the captured images. The method for estimating the factor of accuracy degradation of the measurement will be described in detail below.

The user interface unit 305 has a function of controlling the user interface device including, for example, the display 105, a keyboard, and a pointing device (such as a mouse, a joystick, or a jog dial).

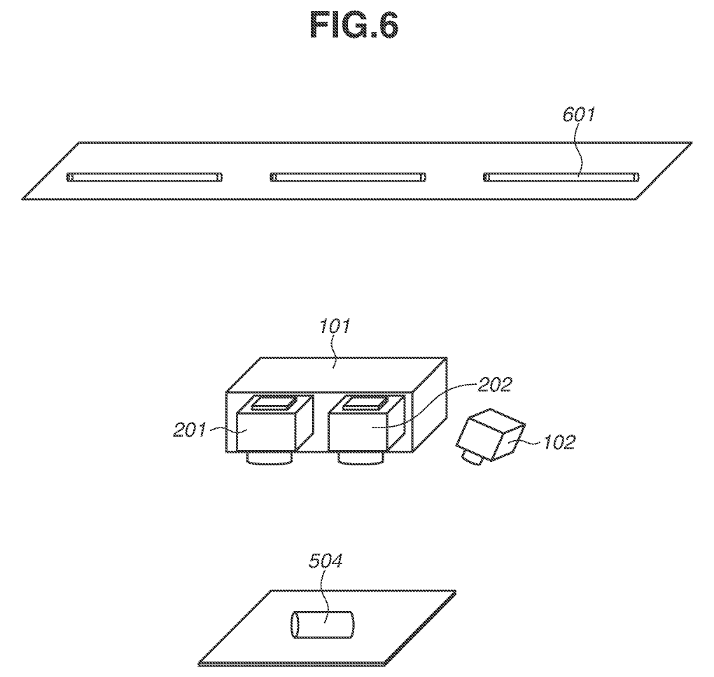

FIG. 6 illustrates a measurement environment in which the workpiece 504 is captured and the three-dimensional measurement is performed using the stereo camera 101 and the pattern light projection unit 102. The workpiece 504 is placed within a common field of view of the monocular cameras 201 and 202 in the stereo camera 101. The pattern light projection unit 102 is arranged so as to project pattern light onto the workpiece 504. Fluorescent lamps 601 are disposed on the ceiling.

Depending on the position and the material of the workpiece 504, overexposure occurs in captured images due to reflected light from the pattern light projection unit 102 or the fluorescent lamps 601, which reduces the accuracy of three-dimensional measurement.

Image anomalies that occur due to environmental light, such as the fluorescent lamps 601, may not be eliminated by only adjustment of the pattern light projection unit 102. Thus, if the factor of an image anomaly can be estimated by isolating whether a factor is the pattern light or the environmental light, the burden on the user who wishes to eliminate the image anomaly can be reduced.

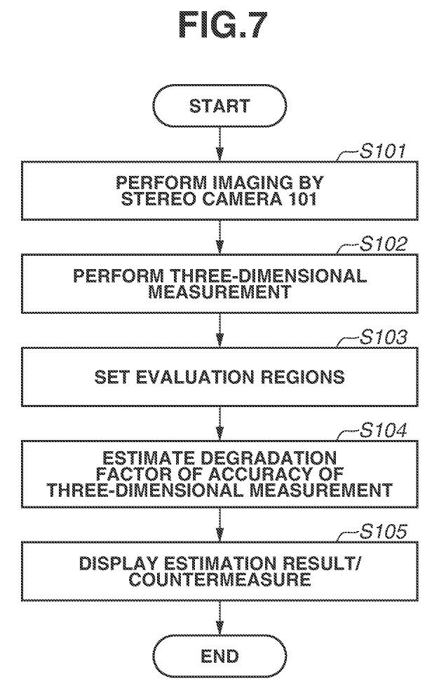

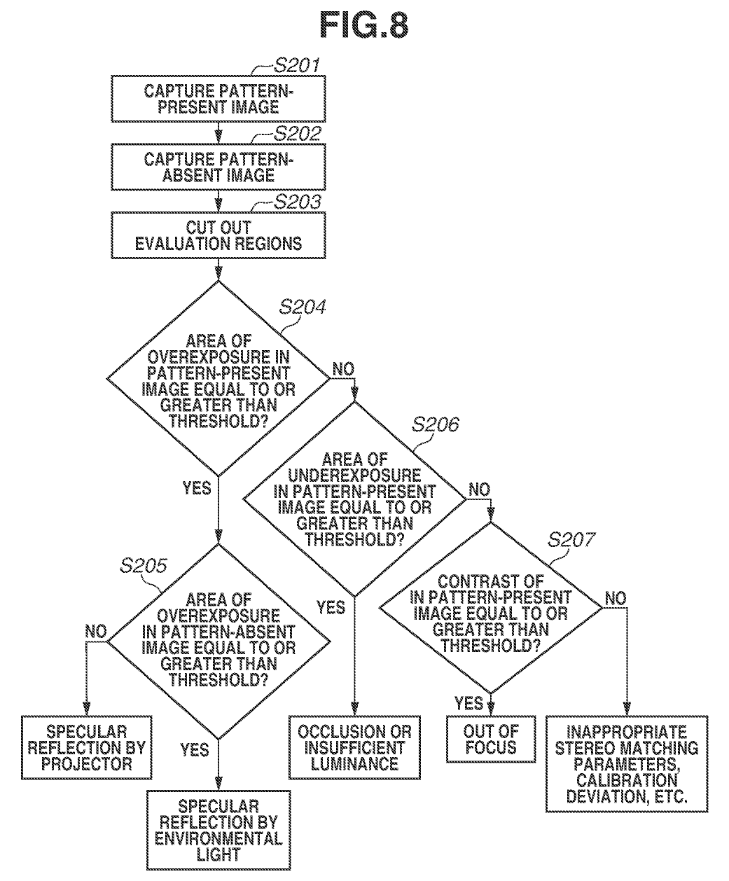

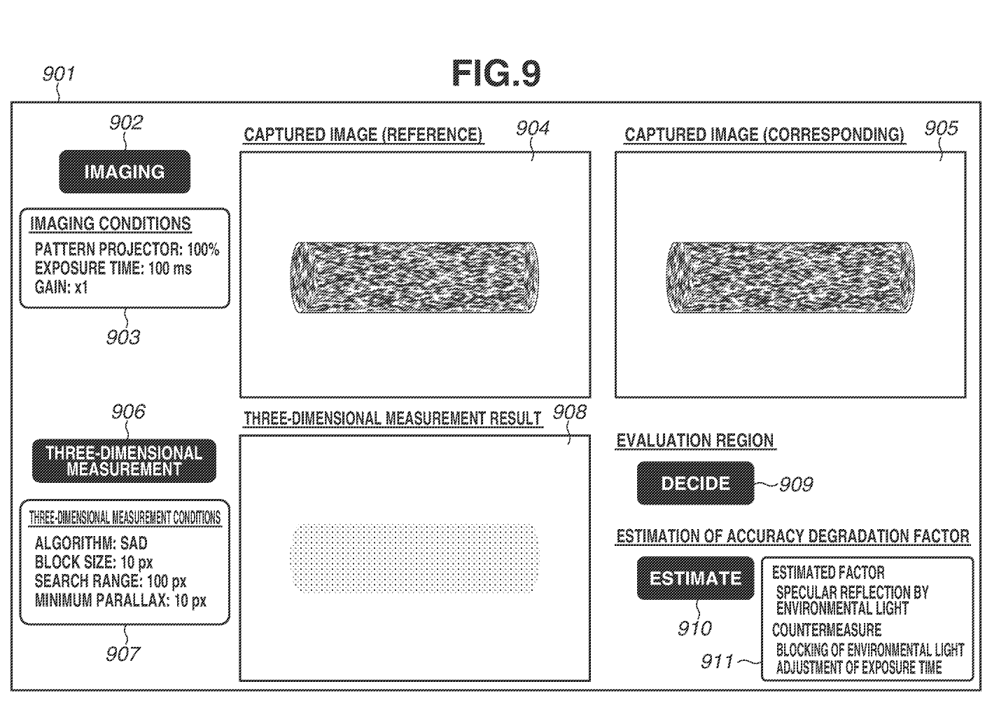

A method of estimating the factor of accuracy degradation of three-dimensional measurement will now be described with reference to FIGS. 7, 8, and 9. FIG. 7 is a flowchart illustrating a series of steps from capturing images with the stereo camera 101 to displaying the result of an estimated factor of accuracy degradation in three-dimensional measurement. FIG. 8 is a detailed flowchart of estimating the factor of accuracy degradation in three-dimensional measurement. FIG. 9 illustrates an example of the screen of a three-dimensional measurement application 901 displayed on the display 105.

In step S101, the image processing apparatus 104 acquires images captured by the stereo camera 101 and displays the captured images in a reference image display window 904 and a corresponding image display window 905. After the user presses an imaging button 902 in the three-dimensional measurement application 901, the images captured by the stereo camera 101 are acquired. An image captured by the monocular camera 201 is displayed as a reference image in the reference image display window 904, and an image captured by the monocular camera 202 is displayed as a corresponding image in the corresponding image display window 905.

Imaging parameters, such as the intensity of the pattern light projection unit 102 during imaging, the exposure time of the stereo camera 101, and the gain, can be set in an imaging condition window 903. The image processing apparatus 104 configures settings for the stereo camera 101 and the pattern light projection unit 102 before performing imaging processing. If the intensity of the pattern light projection unit 102 is set to 0, the image processing apparatus 104 transmits trigger signals to the stereo camera 101 and acquires images with the pattern light turned off. On the other hand, if the intensity is set to a value other than 0, the image processing apparatus 104 transmits a turn-on command to the pattern light projection unit 102, and then transmits trigger signals to the stereo camera 101 to acquire images.

After completion of the image capturing, the image processing apparatus 104 transmits a turn-off command to the pattern light projection unit 102. This makes it possible to acquire images with the pattern light turned on. Further, since the pattern light projection unit 102 is not constantly turned on, it is possible to extend the lifetime of the pattern light projection unit 102 and prevent temperature rise.

In step S102, three-dimensional measurement is performed on the images captured in step S101 using the stereo matching processing described above, and the result is displayed in a three-dimensional measurement result window 908. After the user presses a three-dimensional measurement button 906 in the three-dimensional measurement application 901, the three-dimensional measurement process starts.

Three-dimensional measurement conditions, such as the algorithm for stereo matching processing, the block size, the search range, and the minimum parallax, can be set in a three-dimensional measurement condition window 907. The image processing apparatus 104 sets these conditions before performing three-dimensional measurement. The obtained result of the three-dimensional measurement is displayed in the three-dimensional measurement result window 908. In the three-dimensional measurement result window 908, a three-dimensional point cloud may be displayed in three dimensions, or a distance image in which each pixel of the reference image contains a measurement value in the Z direction may be displayed in two dimensions.

In the present embodiment, the imaging button 902 and the three-dimensional measurement button 906 are separate buttons, but the buttons 902 and 906 may be integrated into one button used to simultaneously execute steps S101 and S102. This reduces the number of times the user presses the buttons, which improves operability.

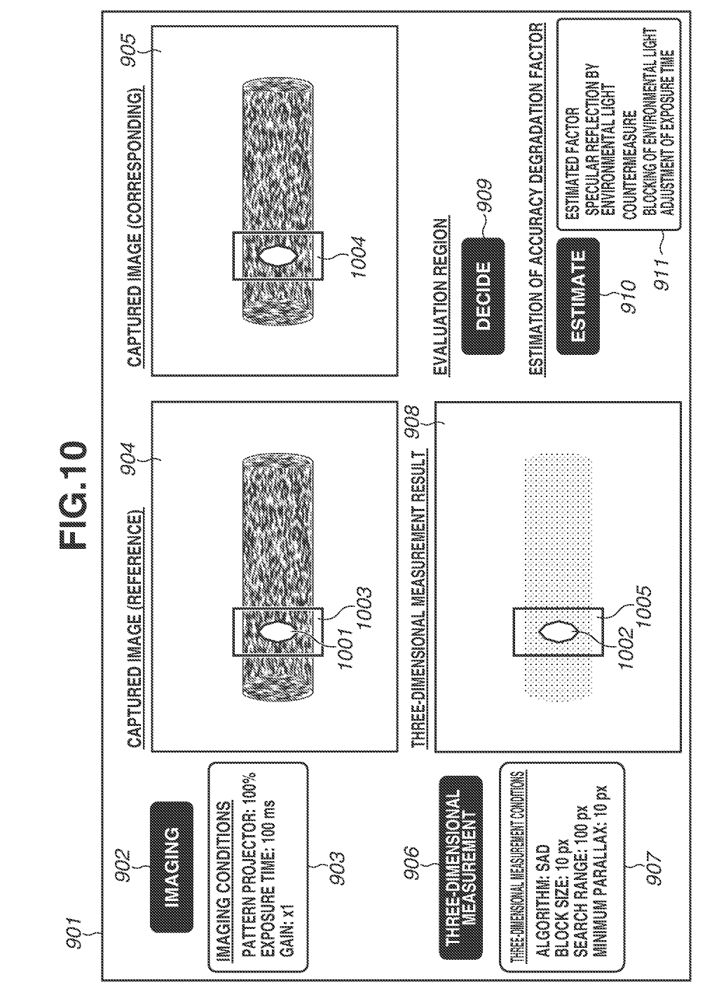

In step S103, the user selects a region, where the user wishes to evaluate a factor of accuracy degradation of the three-dimensional measurement with respect to the three-dimensional evaluation result measured in step S102. As illustrated in FIG. 10, a case will be described where an anomaly region 1002 whose geometry is different from the actual workpiece exists in the three-dimensional measurement result displayed in the three-dimensional measurement result window 908. In the present embodiment, the anomaly region 1002 is defined as a region in which the accuracy of three-dimensional measurement is degraded, i.e., no point cloud data exists or the three-dimensional measurement result is significantly different from the actual workpiece geometry.

When a region with degraded accuracy of three-dimensional measurement exists, the user needs to set an evaluation region 1003 to estimate the factor of the degradation. The user uses a mouse or the like in the three-dimensional measurement result window 908 to select an evaluation region 1005 so as to include the anomaly region 1002.

The three-dimensional measurement result and the reference image are viewed from the same coordinate system reference, and thus, once the evaluation region 1005 is defined on the three-dimensional measurement result, the evaluation region 1003 on the reference image 401 is uniquely determined. On the other hand, the corresponding image 402 is viewed from a different coordinate system, and thus, the evaluation region in the corresponding image is not uniquely determined. As a result, the evaluation region 1004 is also set in the corresponding image display window 905. The evaluation regions 1003, 1004, and 1005 can be set after selecting those regions and by pressing an evaluation region decide button 909. Coordinate value data on the defined evaluation regions is stored in the ROM or the like in the image processing apparatus 104.

In the present embodiment, the evaluation regions 1003, 1004, and 1005 are selected in the three-dimensional measurement result window 908, but the evaluation regions 1003, 1004, and 1005 may be selected in the reference image display window 904. Further, the user manually selects the evaluation regions 1003, 1004, and 1005, but the evaluation regions 1003, 1004, and 1005 may be set automatically by performing image processing on the three-dimensional measurement result.

Examples of an automatic setting method include, in a case where the geometry of the workpiece is known, a method in which a model fitting is performed between the point cloud data and a computer-aided design (CAD) model or the like representing the actual geometry of the workpiece, regions where the discrepancy between the CAD model and the point cloud data is large are identified as anomaly regions, and the vicinity of the anomaly regions is set as the evaluation regions. Alternatively, in the case of measuring a uniform plane, for example, a method can be used in which a binarization process is applied to a distance image using distance information, regions below a threshold are determined to be anomaly regions, and the vicinity of those anomaly regions is set as the evaluation regions. This eliminates the need for the user to select the evaluation region, which improves workability.

If the user wishes to evaluate the entire image, step S103 may be omitted.

If step S103 is omitted, the entire image will be automatically set as the evaluation region.

In step S104, the factor of accuracy degradation of the three-dimensional measurement in the evaluation regions 1003, 1004, and 1005 set in step S103 is estimated. FIG. 8 is a flowchart of estimating the factor of accuracy degradation of the three-dimensional measurement. The details of this flowchart will be described below.

In step S105, the factor estimated in step S104 and a countermeasure are displayed in an estimation result window 911. The user can easily take a countermeasure based on the countermeasure displayed in this window.

The procedure of estimating the factor of accuracy degradation of the three-dimensional measurement, which is performed in step S104, will be described in detail with reference to the flowchart of FIG. 8.

In step S201, the pattern light projection unit 102 is turned on and images captured by the stereo camera 101 are acquired. The imaging conditions are the same as those in imaging in step S101. In the present embodiment, the images captured in this step will be referred to as images with patterns. Among the images with patterns, the reference image 401 will be referred to as a first image with a pattern. Similarly, among the images with patterns, the corresponding image 402 will be referred to as a second image with a pattern. In the present embodiment, new images with patterns are captured for estimation, but the captured images for three-dimensional measurement obtained in step S101 may be reused.

In step S202, the pattern light projection unit 102 is turned off and images captured by the stereo camera 101 are acquired. The imaging conditions other than the intensity of the pattern light projection unit 102 are the same as those in imaging in step S101. In the present embodiment, the images captured in this step will be referred to as images without patterns. Among the images without patterns, the reference image 401 will be referred to as a first image without a pattern. Similarly, among the images without patterns, the corresponding image 402 will be referred to as a second image without a pattern.

In step S203, the data about the evaluation regions 1003 and 1004 set in step S103 is read, and images of the evaluation regions are extracted from the images with patterns and the images without patterns captured in steps S201 and S202. In the subsequent steps, image processing is performed on the images of the evaluation regions extracted here, and the factor of accuracy degradation of the three-dimensional measurement is estimated.

In step S204, a first evaluation result is derived, which indicates whether the area of an overexposed region in an evaluation region of the image with the pattern is equal to or larger than a threshold. If the first evaluation result is equal to or larger than the threshold (YES in step S204), the process proceeds to step S205. If the first evaluation result is smaller than the threshold (NO in step S204), the process proceeds to step S206. The overexposure here refers to a state in which the luminance levels off in the captured image.

An example will now be described of a method for calculating the area of an overexposed region. An approximate value of the luminance in the level-off state is set as a luminance threshold. For example, in a captured image with an 8-bit depth, the maximum luminance is 255. However, due to fixed pattern noise or the like of the image sensor 203, even if pixels are in the overexposed state, the luminance does not necessarily be 255. Thus, a predetermined value, for example, a value in the vicinity of the maximum luminance (250 or the like), is set as the luminance threshold. This makes it possible to extract a region (a blob) whose luminance is equal to or greater than the luminance threshold within the evaluation region using binarization processing to calculate the area from the number of pixels of the blob.

An area threshold is set based on the size of the evaluation region. For example, if the evaluation region is 100 × 100 pixels (px), the area (the number of pixels) of the evaluation region is 10,000. The area threshold can be set based on the percentage relative to the area. For example, if the percentage is 80%, the area threshold is 8,000. A determination can be made based on whether the blob area calculated earlier is larger than the area threshold.

The luminance threshold and the area threshold of the overexposed region set as described above vary depending on the use case. Thus, these thresholds can be parameters adjustable in the three-dimensional measurement application 901. For example, in use cases where fine structures are to be measured three-dimensionally, in one embodiment, the regions with degraded accuracy in the three-dimensional measurement is to be small. In this case, setting the luminance threshold and the area threshold to small values makes it possible to determine even a small overexposed region.

In step S205, a second evaluation result is derived, which indicates whether the area of the overexposed region in an evaluation region of the image without a pattern is equal to or larger than a threshold. The method of determining the area of the overexposed region is the same as that in step S204. Steps S204 and S205 make it possible to determine that the factor of the accuracy degradation of the three-dimensional measurement is overexposure, and to isolate whether a factor of the overexposure is attributable to the pattern light projection unit or the environmental light.

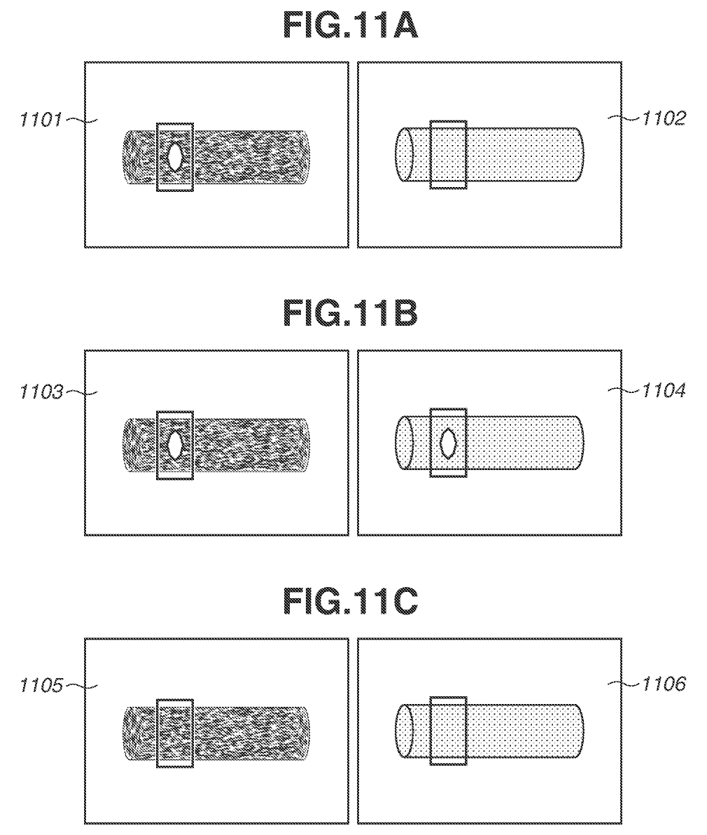

The method for the isolation will be described with reference to FIGS. 11A to 11C. FIG. 11A is a diagram illustrating a case where overexposure occurs in an image with the pattern 1101 in step S204, while no overexposure occurs in an image without a pattern 1102 in step S205. The occurrence of overexposure means that the stereo camera 101 likely captures specularly reflected light. Overexposure no longer occurs with the pattern light 103 turned off, which indicates that overexposure is caused by specular reflection of light from the pattern light projection unit 102. In this case, a countermeasure can be taken by changing the arrangement of the pattern light projection unit 102, adjusting the intensity of light projection, and/or shortening the exposure time of the stereo camera 101.

FIG. 11B is a diagram illustrating a case where overexposure occurs in the image with the pattern 1103 in step S204, while overexposure also occurs in the image without a pattern 1104 in step S205. Overexposure occurs even after turn-off of the pattern light 103, which indicates that overexposure occurs due to specular reflection of environmental light from the fluorescent lamps 601 or the like. In this case, a countermeasure can be taken by blocking the light from the fluorescent lamps 601 with a light shield or the like, changing the position of the workpiece 504, or shortening the exposure time of the stereo camera 101.

FIG. 11C is a diagram illustrating a case where no overexposure occurs in the image with the pattern 1103 in step S204, and no overexposure occurs in the image without a pattern 1104 in step S205. Since no overexposure occurs as described above, it can be determined that other factors exist. The process proceeds to step S206. In step S206, the other factors are estimated.

In step S206, a third evaluation result is derived, which indicates whether the area of an underexposed region in the evaluation region of the image with the pattern is equal to or greater than a threshold. The underexposure here refers to a state in which the luminance value is close to zero in a captured image. In this case, the contrast of the pattern light 103 cannot be obtained, and thus, the stereo matching processing cannot be performed properly. If the area is not equal to or greater than the threshold (NO in step S206), the process proceeds to step S207. On the other hand, if the area is equal to or greater than the threshold (YES in step S206), it can be determined that the insufficient luminance of the pattern light 103 received by the stereo camera 101 is the factor of accuracy degradation of the three-dimensional measurement. If the light from the pattern light projection unit 102 is blocked by an obstruction or the like (an occlusion), a countermeasure can be taken by removing the obstruction and/or by increasing the exposure time of the stereo camera 101.

An example will be described of a method for calculating the area of an underexposed region. Even if no light is incident on the image sensor 203, the luminance does not necessarily to be zero due to dark current noise in the image sensor 203 or the like. Thus, a predetermined value, for example, a luminance value close to zero (five or the like), is set as the luminance threshold. This makes it possible to extract a region (a blob) within the evaluation region, the region whose luminance is equal to or less than the luminance threshold using binarization processing to calculate the area from the number of pixels of the blob. The area threshold is the same as that of the overexposed region, and thus, the description thereof will be omitted.

As in the case of the overexposed region, the luminance threshold and the area threshold for the underexposed region set using the methods vary depending on the use case, and thus, those thresholds can be parameters adjustable in the three-dimensional measurement application 901.

In step S207, a fourth evaluation result is derived, which indicates whether the contrast of the pattern in the evaluation region of the image with the pattern is equal to or greater than a threshold. The contrast is the difference between a bright part and a dark part in a captured image. For example, the contrast can be calculated using (dmax – dmin)/(dmax + dmin), where the luminance of the bright part is dmax and the luminance of the dark part is dmin.

As described above, a low contrast (a weak texture) results in reduced performance of the stereo matching processing. If the contrast is lower than the threshold, the low contrast can be determined to be a factor of accuracy degradation of three-dimensional measurement. In this case, it is estimated that the pattern light 103 is outside the focus range of the stereo camera 101. Thus, a countermeasure can be taken by adjusting the arrangement of the pattern light projection unit 102 so that the pattern light 103 is in focus, and/or by adjusting the arrangement of the stereo camera 101 so that the camera is in focus.

On the other hand, a contrast equal to or greater than the threshold means that the contrast is sufficient, and it can be determined that there are other factors that cause the accuracy degradation of the three-dimensional measurement. One factor may be inappropriate parameters for the stereo matching processing. For example, if the search range and the minimum parallax are set inappropriately, the height at which the workpiece is actually placed is outside the search range in some cases. Thus, a countermeasure can be taken by adjusting the parameters for the stereo matching processing. In this manner, revising the parameter adjustment for the stereo matching processing is presented as a specific countermeasure in the estimation result window 911.

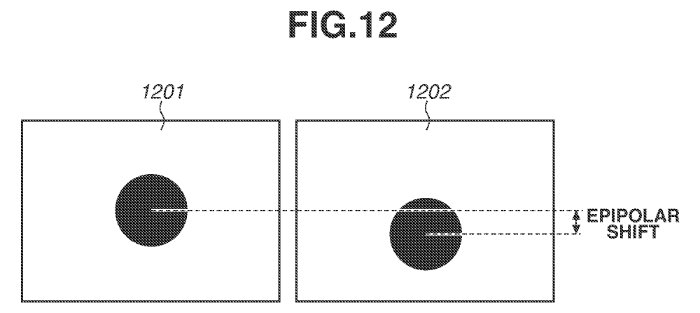

If no improvement is seen even after revising the parameter adjustment, it can be considered that the intrinsic and the extrinsic parameters of the stereo camera 101 have changed since the time of calibration. For example, if the environmental temperature in the place of use is high, the holding mechanism of the monocular cameras 201 and 202 may be thermally deformed. In this case, as illustrated in FIG. 12, images of marker plates, such as white boards with black circles thereon, are captured, and the center positions of the black circles in a reference image 1201 and a corresponding image 1202 are measured. If no calibration deviation occurs, the displacement of these center positions (the epipolar disparity) is close to 0 px. On the other hand, if a calibration deviation occurs, the epipolar disparity is large. In this manner, it can be determined whether the epipolar disparity is within an allowable range. The allowable range can be 1 px or less while the allowable range depends on the required accuracy.

As described above, the procedure of steps S201 to S207 makes it possible to estimate the factor of accuracy degradation of the three-dimensional measurement and present the user with a countermeasure.

### Second Embodiment

In the first embodiment described above, in setting the evaluation regions in step S103, the user sets the evaluation regions 1003 and 1004 with respect to the reference image and the corresponding image, respectively. However, in some cases, it is difficult to find the same region in the corresponding image as the evaluation region 1003 in the reference image.

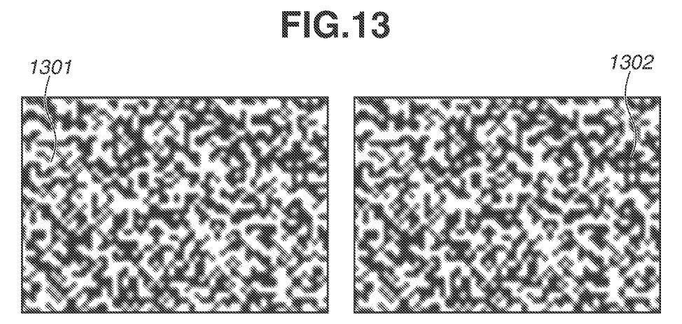

As illustrated in FIG. 13, for example, if the pattern light 103 is projected onto a uniform plane to capture images, it may be extremely difficult for the user to visually find the same positions in a reference image 1301 and a corresponding image 1302. Thus, there is an issue that it may be difficult to set evaluation regions in the same places in the reference image 1301 and the corresponding image 1302. In the present embodiment, a method will be described in which if an evaluation region is set in one image, and then an evaluation region is automatically set in the other image.

The parts of processing in the procedure that are different from those of the first embodiment will be illustrated and described. The same components as those of the first embodiment can have the same configuration and function described above, and detailed descriptions thereof will be omitted.

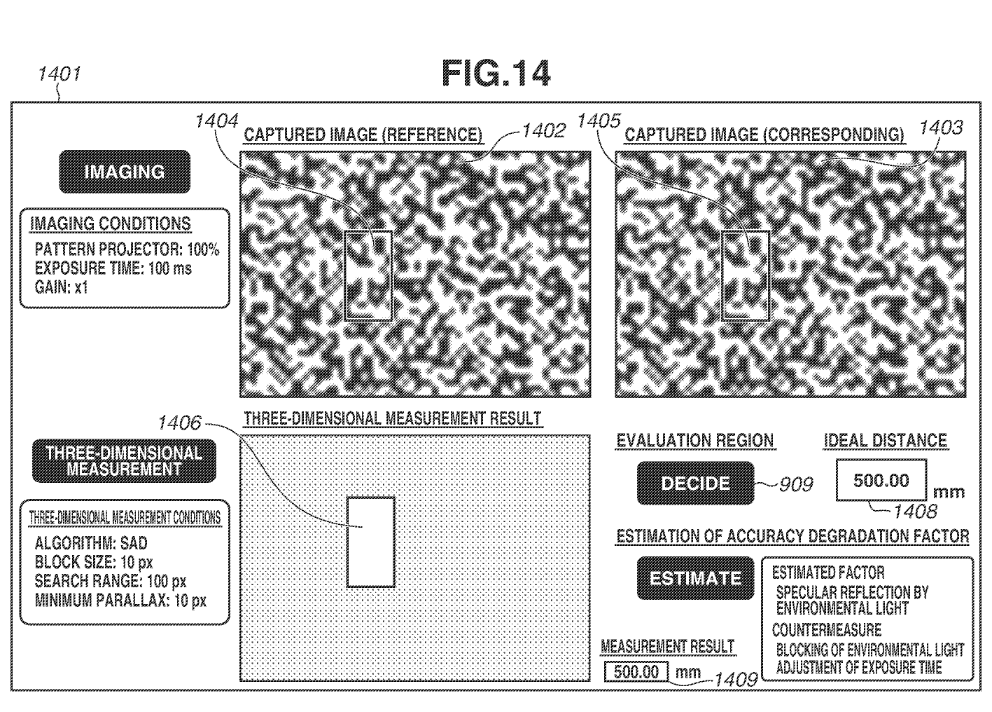

FIG. 14 illustrates an example of a display screen of a three-dimensional measurement application 1401 in the present embodiment. In this example, pattern light 103 is projected onto a uniform plane to capture images. The three-dimensional measurement application 1401 includes a plurality of input portions. The user can set an evaluation region and input an ideal distance using the above-described user interface device. In the present embodiment, a case will be described where an evaluation region 1404 is set by the user in a reference image window 1402, and an evaluation region 1405 is automatically set in a corresponding image window 1403. As described above, an evaluation region 1406 of the three-dimensional measurement result has the same coordinate values as those of the evaluation region 1404 in the reference image window 1402, and thus, description of a method for setting the evaluation region 1406 will be omitted.

First, the user sets the evaluation region 1404 in the reference image window 1402 as in the first embodiment. Next, the user inputs an ideal distance to the evaluation region 1404 in an ideal distance window 1408. The ideal distance here refers to a distance obtained through correct measurement by the stereo camera 101. The user can estimate this ideal distance from the measurement value(s) in the vicinity of the evaluation region 1404 and the like.

For example, a uniform plane is measured in the present embodiment, and thus, the ideal distance is the same value as the distance value of the region in the vicinity of the evaluation region that is correctly measured. The user can easily know the distance value in the vicinity of the evaluation region with the displayed distance value of the area dragged with the mouse in a distance measurement result window 1409 as a three-dimensional measurement result window. Alternatively, if the geometry of the workpiece is known, the ideal distance can be estimated from the geometry of the workpiece.

A method will now be described of calculating the evaluation region 1405 in the corresponding image window 1403. As described above, the measurement result z can be expressed as z = Bf/d, where B is the baseline length, f is the focal length, and d is the parallax. Thus, if an ideal distance zi is found, an ideal parallax di can be calculated using di = Bf/zi.

Let cl denote the value in a column direction at the center of the evaluation region 1404 in the reference image window 1402, a value cr in the column direction at the center of the evaluation region 1405 in the corresponding image window 1403 can be calculated using cr = cl – di. Because of the epipolar constraint, the values in a row direction are equal in the reference image and the corresponding image.

The user can determine whether the evaluation region 1405 in the corresponding image window 1403 is at the desired position by checking the evaluation region 1405. If the position of the evaluation region 1405 is changed in conjunction with the change in the value of the ideal distance window 1408, the user can make fine adjustments while checking the position of the evaluation region 1405. After checking that the evaluation region 1405 is at the desired position, the user sets the evaluation regions 1404, 1405, and 1406 by pressing the evaluation region decide button 909. In this manner, the evaluation region 1405 in the corresponding image window 1403 can be set automatically.

In the present embodiment, the evaluation region 1405 in the corresponding image window 1403 is automatically determined. However, the evaluation region 1405 in the corresponding image window 1403 may be manually set by the user, and the evaluation region 1404 in the reference image window 1402 may be set automatically using a similar method. In other words, the evaluation region used to derive the first evaluation result can be derived from the evaluation region of either the first image with a pattern or the second image with a pattern, and the distance from the stereo camera 101 to the workpiece 504.

In the present embodiment, the ideal distance is input in the ideal distance window 1408. However, the ideal distance may be set automatically by inferring from the distance value in the vicinity of the evaluation region. This eliminates the need for the user to input the ideal distance, which improves usability.

### Third Embodiment

In the first and second embodiments described above, in step S105, a countermeasure is only displayed in the estimation result window 911, and the user needs to manually take a countermeasure, which may take time. In the present embodiment, a method will be described of automatically executing a countermeasure if it is expected that the countermeasure can run automatically.

The parts of processing in the procedure that are different from those of the first and second embodiments will be illustrated and described. The same components as those of the first and second embodiments can have the same configuration and function described above, and detailed descriptions thereof will be omitted.

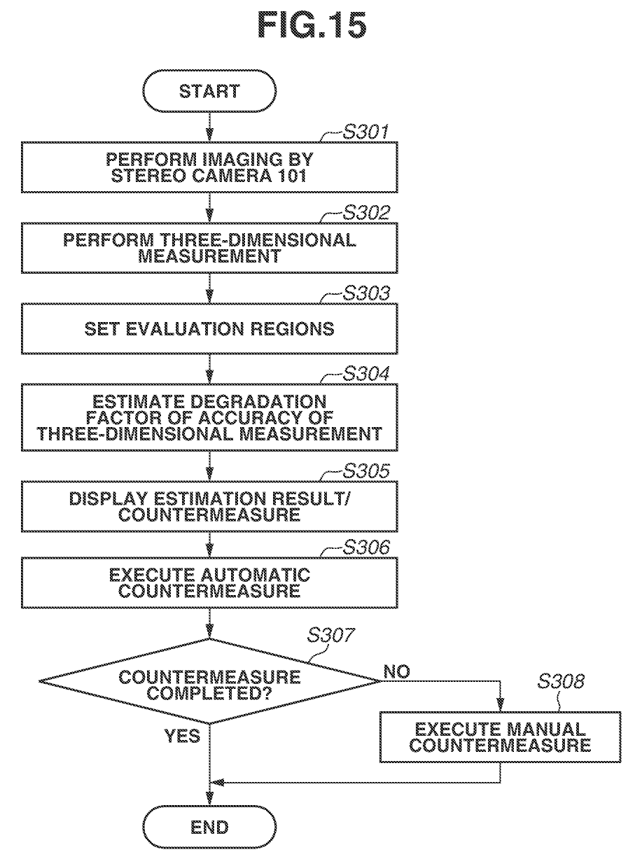

FIG. 15 is a flowchart illustrating a series of steps from capturing images with a stereo camera 101 through estimating the factor of accuracy degradation of the three-dimensional measurement to taking a countermeasure in the present embodiment. Steps S301 to S303 are the same as steps S101 to S103 in the first embodiment, and the description will be omitted.

In step S304, the factor of accuracy degradation of the three-dimensional measurement in the evaluation region set in step S303 is estimated, and an automatic countermeasure and a manual countermeasure are estimated. In one embodiment, the automatic countermeasure can be performed only by adjusting parameters or the like of the software installed in an image processing apparatus 104.

An example will be described of the automatic countermeasure. A case will be described in which overexposure occurs to degrade the accuracy of three-dimensional measurement. In this case, shortening the exposure time of the stereo camera 101 could improve the accuracy. On the other hand, if underexposure occurred, increasing the exposure time of the stereo camera 101 could improve the accuracy.

An example will be described of the manual countermeasure. For example, a light shielding plate may be installed to block environmental light. As described above, a manual countermeasure cannot be controlled by the image processing apparatus 104.

In the present embodiment, the adjustment of the exposure time alone has been described. However, a countermeasure may be taken to perform high dynamic range (HDR) synthesis on images captured with a plurality of exposure times.

This makes it possible to take a countermeasure against both overexposure and underexposure. If the illumination adjustment of a pattern light projection unit 102 is controllable, a countermeasure may be taken by controlling illumination adjustment. Increasing the exposure time will increase the imaging time, but a countermeasure can be taken without changing the imaging time by controlling the illumination adjustment.

In step S305, the factor of accuracy degradation of the three-dimensional measurement estimated in step S304, a countermeasure that can be taken automatically, and a countermeasure that cannot be taken without manual intervention are displayed in an estimation result window 1603. The countermeasure that can be taken automatically and the countermeasure that cannot be taken without manual intervention can be displayed separately. If a plurality of countermeasures exists that can be taken automatically in step S304, a countermeasure can be selected from among the countermeasures here.

In step S306, pressing a countermeasure execution button 1602 executes the countermeasure displayed in the estimation result window. After the countermeasure is executed, imaging is performed again and three-dimensional measurement is performed, and the results after the countermeasure are displayed in a reference image display window 904, in a corresponding image display window 905, and in a three-dimensional measurement result window 908 of a three-dimensional measurement application 1601.

An example of the countermeasures will now be described. A case will be described where overexposure occurs to degrade the accuracy of three-dimensional measurement. In this case, the image processing apparatus 104 gradually shortens the exposure time of the stereo camera 101, performs the same steps as steps S204 to S207 in the first embodiment on each captured image to determine whether the image in the evaluation region is suitable for three-dimensional measurement. Being suitable for three-dimensional measurement means that the cases where the results of the determination in steps S204, S206, and S207 are No.

Once the range of exposure time suitable for three-dimensional measurement is determined, an appropriate exposure time is set within the range. For example, if the exposure time between 10 milliseconds (ms) and 100 ms is determined to be suitable for three-dimensional measurement, the exposure time is set to 55 ms, which is an intermediate value. The exposure time after the countermeasure is displayed in an imaging condition window 903.

In step S307, it is determined whether the countermeasure executed in step S306 is sufficient based on the result displayed in the three-dimensional measurement result window 908. If the countermeasure is insufficient (NO in step S307), the process proceeds to step S308. As a method of the determination, the user can visually determine from the three-dimensional measurement result. Alternatively, in the case of performing post-processing on the three-dimensional measurement result, the user may execute a post-processing program to determine whether sufficient accuracy is obtained from the post-processing.

In step S308, when the automatic countermeasure in the estimation result window 1603 does not improve the situation, the user takes the displayed manual countermeasure. After taking the manual countermeasure, the user performs imaging and three-dimensional measurement again. The manual countermeasure is continued until its completion.

These advantageous effects are merely a list of the most favorable advantageous effects resulting from the technology of the present disclosure, and advantageous effects of the technology of the present disclosure are not limited to those described above.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167062, filed September 26, 2024, which is hereby incorporated by reference herein in its entirety.

What is claimed is:

1. An apparatus that performs three-dimensional measurement, the apparatus comprising:
a projection unit configured to project pattern light onto an object to be measured;
a camera including a first camera and a second camera, the camera being configured to capture images of the object; and
a processing unit configured to process data acquired from the camera,
wherein the processing unit derives a first evaluation result from a first image with a pattern acquired by the first camera and a second image with a pattern acquired by the second camera in a state in which the pattern light is projected, and
wherein the processing unit derives a countermeasure for improving accuracy of the three-dimensional measurement based on the first evaluation result.

2. The apparatus according to claim 1,
wherein the processing unit derives a second evaluation result from a first image without the pattern acquired by the first camera and a second image without the pattern acquired by the second camera in a state in which the pattern light is not projected, and
wherein the processing unit derives the countermeasure using the first evaluation result and the second evaluation result.

3. The apparatus according to claim 2, wherein, based on the first evaluation result and the second evaluation result, it is determined whether the countermeasure is a countermeasure against the pattern light of the projection unit or a countermeasure against environmental light in an environment in which the apparatus is installed.

4. The apparatus according to claim 1, wherein the first evaluation result is derived as an area of a blob having a luminance value higher than a predetermined value.

5. The apparatus according to claim 2, wherein the second evaluation result is derived as an area of a blob having a luminance value higher than a predetermined value.

6. The apparatus according to claim 1, wherein the processing unit derives a third evaluation result as an area of a blob having a luminance value lower than a predetermined value from the first image with the pattern and the second image with the pattern.

7. The apparatus according to claim 6, wherein it is determined based on the third evaluation result whether the countermeasure relates to a luminance of the pattern light received by the camera.

8. The apparatus according to claim 7, wherein the processing unit derives a fourth evaluation result as a contrast that is a difference between a bright part and a dark part from the first image with the pattern and the second image with the pattern.

9. The apparatus according to claim 8, wherein it is determined based on the fourth evaluation result whether the countermeasure relates to a focus of the camera with respect to the pattern light.

10. The apparatus according to claim 1, wherein the processing unit derives an evaluation region for use to derive the first evaluation result from an evaluation region of one of the first image with the pattern and the second image with the pattern, and a distance from the camera to the object.

11. The apparatus according to claim 10, further comprising a display unit,
wherein the processing unit causes the display unit to display an input portion for inputting any one of the evaluation regions, and the distance.

12. The apparatus according to claim 1, further comprising a display unit,
wherein the processing unit causes the display unit to display the countermeasure.

13. The apparatus according to claim 12, wherein the display unit displays, as the countermeasure, separately a countermeasure that does not require manual intervention in execution the countermeasure and a countermeasure that requires manual intervention in execution the countermeasure.

14. The apparatus according to claim 1, wherein the camera incorporates the processing unit.

15. An apparatus that performs three-dimensional measurement, the apparatus comprising:
a control unit configured to control a projection unit configured to project pattern light onto an object to be measured; and
a processing unit configured to process data acquired from a camera,
wherein the processing unit derives a first evaluation result from a first image with a pattern acquired by a first camera included in the camera and a second image with a pattern acquired by a second camera included in the camera in a state in which the pattern light is projected onto the object by the control unit, and
wherein the processing unit derives a countermeasure for improving accuracy of the three-dimensional measurement based on the first evaluation result.

16. A method for an apparatus that performs three-dimensional measurement, the apparatus including a projection unit configured to project pattern light onto an object to be measured, a camera including a first camera and a second camera, the camera being configured to capture images of the object, and a processing unit configured to process data acquired from the camera, the method comprising:
deriving a first evaluation result from a first image with a pattern acquired by the first camera and a second image with a pattern acquired by the second camera in a state in which the pattern light is projected, and
deriving a countermeasure for improving accuracy of the three-dimensional measurement based on the first evaluation result.

17. A non-transitory computer-readable storage medium storing a program according to claim 16.

18. A manufacturing method of an item, the manufacturing method comprising:
manufacturing an item; and
inspecting the item manufactured in the manufacturing by the apparatus according to claim 1.
